(19) United States
(12) Patent Application Publication
(10) Pub. No.: US 2026/0309022 A1
(43) Pub. Date: Oct. 8, 2026

(54) SYSTEMS AND METHODS FOR DEPLOYING AND RETRIEVING MAGNETICALLY COUPLED TEMPORARY WIRELINE FIBER FOR BROADSIDE WAVE DETECTION

(71) Applicant: ESG SOLUTIONS GROUP, INC., Houston, TX (US)

(72) Inventors: Trevor Keith Charles PUGH, Tomball, TX (US); Keith GRAHAM, Houston, TX (US); Chris HAWRYLUCK, Houston, TX (US); Rob NELSON, Houston, TX (US); Suresh DANDE, Houston, TX (US)

(21) Appl. No.: 19/641,245

(22) Filed: Apr. 7, 2026

Related U.S. Application Data
(60) Provisional application No. 63/784,858, filed on Apr. 7, 2025.

(51) Int. Cl. E21B 47/01; G01D 11/30; G01H 9/00; G02B 6/50; H01F 7/02

(52) U.S. Cl. CPC E21B 47/01; G01D 11/30; G01H 9/004; G02B 6/502; H01F 7/0221; H01F 7/0252

(57) ABSTRACT

Wireline fiber assembly systems include magnetic clamps having a clamp body positioned around a fiber optic cable, the magnetic clamps having magnets protruding therefrom for contact with an inner surface of a casing of a wellbore. Methods of deploying, coupling, and retrieving a wireline fiber assembly in a wellbore during downhole monitoring campaigns include deploying the wireline fiber assembly into a wellbore, magnetically coupling magnetic clamps in a nonlinear arrangement along the casing of the wellbore, and decoupling the magnetic clamps and retrieving the wireline fiber assembly from the wellbore. Methods further include monitoring wireline load during deployment and retrieval relative to a pullout load rating or a rig-in load rating of surface equipment.

### CROSS-REFERENCE TO RELATED APPLICATION(S)

This application is related to and claims the benefit of priority from U.S. Provisional Application Number 63/784,858, titled “METHOD FOR SAFE DEPLOYMENT AND RETRIEVAL OF MAGNETICALLY COUPLED TEMPORARY WIRELINE FIBER THAT ENHANCES THE DETECTION OF BROADSIDE WAVES,” filed on Apri. 7, 2025, the full disclosure of which is hereby incorporated by reference in its entirety for all purposes.

### BACKGROUND

### 1. Field of Disclosure

Embodiments of the present disclosure generally relate to temporary wireline fiber deployment and retrieval in cased wellbores. In particular, embodiments of the present disclosure relate to magnetically coupled clamp assemblies that maintain load limits, accommodate upset casing, and enhance broadside wave detection.

### 2. Description of Related Art

Subsurface resource development operations increasingly depend on downhole measurements to characterize reservoirs, verify well integrity, and improve the efficiency of production and injection activities. In this context, fiber optic sensing has become a widely used measurement platform because a single optical fiber can support multiple sensing modalities, including distributed acoustic sensing (DAS), distributed strain sensing (DSS), and distributed temperature sensing (DTS). By interrogating backscattered light along the length of a continuous fiber, operators can obtain high-resolution, real-time data over long well intervals without deploying numerous discrete gauges. These distributed measurements are utilized in a range of applications, such as monitoring hydraulic fracturing and microseismic activity, profiling flow in producing and injecting wells, detecting leaks and evaluating well integrity, surveilling geothermal reservoirs, and supporting monitoring programs for carbon capture, utilization, and storage (CCUS) projects.

In many installations, fiber optic cables are deployed permanently along casing or tubing. Permanent installation techniques—such as cementing a fiber to casing, strapping or clamping fibers along casing joints, or using mechanical fasteners—can provide stable placement and high signal fidelity over extended periods. However, such installations typically involve increased installation complexity, higher cost, and limited flexibility once installed. As a result, for trial deployments, short-duration monitoring programs, or post-completion diagnostic campaigns, operators often prefer temporary solutions that can be deployed and retrieved with minimal disruption to ongoing well operations.

Temporary deployment of fibers within cased wellbores is frequently performed using wireline conveyance. Wireline operations allow sensing elements to be delivered to depth and recovered efficiently. Nevertheless, in a temporary configuration, the effectiveness of acoustic and strain measurements can depend strongly on the degree of mechanical coupling between the fiber (or a supporting structure for the fiber) and the casing wall. A fiber that is freely suspended, centrally located, or otherwise insufficiently coupled may be partially decoupled from casing motion and formation-borne signals, which can reduce sensitivity and degrade measurement quality. Achieving adequate coupling in a temporary context is complicated by wellbore realities, including variations in internal diameter or the presence of scale, corrosion, debris, and other non-uniformities that can impede smooth passage and prevent consistent, reliable contact with the casing.

Operational constraints further influence how temporary fiber deployments can be implemented. Wireline conveyance imposes load limits dictated by cable strength, surface winch capacity, and toolstring ratings. Mechanisms intended to promote casing contact or attachment must therefore be compatible with safe working loads and must not introduce retrieval risks that could lead to costly and time-consuming retrieval operations. Further, reliable decoupling and recovery of the wireline are typically required to avoid leaving hardware in the well and to enable rapid turnaround between monitoring operations. These practical considerations highlight a recurring tradeoff in temporary fiber deployments: increasing mechanical coupling generally improves signal quality for DAS, DSS, and DTS, but can raise the risk of exceeding allowable loads or encountering retrieval difficulties, such as in the presence of non-uniform casing conditions.

Furthermore, when a fiber optic cable is deployed primarily in a straight, vertical orientation in a wellbore, the sensing response can be dominated by strain along the fiber axis. In such cases, acoustic waves propagating substantially perpendicular to the fiber axis (broadside waves) are measured less effectively. To overcome this drawback, those in the industry may attempt introducing curvature or angles in the fiber optic cable, such as by, for example, wrapping the fiber optic cable around a 3 axis mandrel in the borehole, the outside of the casing, or on a wellhead, which can be expensive and lead to operational inefficiencies.

### SUMMARY

Applicant recognized the problems noted above herein and conceived and developed embodiments of a magnetically coupled temporary wireline fiber system with magnetic clamps, according to the present disclosure, that safely couples to casing and controls loads for reliable deployment and retrieval.

In an embodiment, a method for deploying a wireline fiber assembly in a wellbore includes providing magnets in a housing of each magnetic clamp of a plurality of magnetic clamps and assembling the wireline fiber assembly having a fiber optic cable and the plurality of magnetic clamps. Each magnetic clamp of the plurality of magnetic clamps is disposed around the fiber optic cable, and the fiber optic cable extends through each magnetic clamp of the plurality of magnetic clamps. The method further includes deploying the wireline fiber assembly into the wellbore, and a casing disposed inside the wellbore extends along a longitudinal axis of the wellbore. Additionally, the method includes magnetically coupling the plurality of magnetic clamps to an inner surface of the casing, thereby mechanically coupling the fiber optic cable to the casing. The method further includes disposing the fiber optic cable within the wellbore in an orientation, the orientation being substantially non-parallel to the longitudinal axis.

In another embodiment, a magnetic clamp for a wireline fiber assembly includes a clamp body extending along a longitudinal axis. The clamp body includes a central bore configured to receive a fiber optic cable and a first and a second body portion, and the first and second body portions each include at least one face surface defining a plane substantially parallel to the longitudinal axis, and include at least one tapered end. The magnetic clamp also includes one or more magnets each having a substantially cylindrical or disk shape, the one or more magnets positioned between the first body portion and the second body portion. The one or more magnets protrude beyond an exterior surface of the clamp body for contact with a casing of a wellbore.

In another embodiment, a method of deploying and retrieving a wireline fiber assembly in a wellbore during a downhole monitoring campaign includes deploying the wireline fiber assembly into the wellbore having a wellbore axis, the wireline fiber assembly having a fiber optic cable and a plurality of magnetic clamps attached to the fiber optic cable. The method also includes magnetically coupling the plurality of magnetic clamps in a substantially helical arrangement along an inner surface of a casing of the wellbore and applying magnetic coupling strength sufficient to maintain coupling of the plurality of magnetic clamps to the inner surface of the casing, while remaining below a pullout load rating or a rig-in load rating of surface equipment. Additionally, the method includes monitoring wireline load during deployment of the wireline fiber assembly such that the wireline load remains below a working load safety limit. The method further includes decoupling the plurality of magnetic clamps from the inner surface of the casing and retrieving the wireline fiber assembly from the wellbore.

### BRIEF DESCRIPTION OF DRAWINGS

The present technology will be better understood on reading the following detailed description of non-limiting embodiments thereof, and on examining the accompanying drawings, in which:

FIG. 1A is a perspective view of a magnetic clamp assembly attached to a fiber optic cable passing through the clamp body, for use in a wireline fiber deployment, in accordance with embodiments of the present disclosure;

FIG. 1B is a cross-sectional perspective view of the magnetic clamp assembly attached to a fiber optic cable passing through the clamp body, for use in a wireline fiber deployment, in accordance with embodiments of the present disclosure;

FIG. 2A is a perspective view of an alternative magnetic clamp assembly having an adjustable clamping mechanism, the alternative magnetic clamp assembly for use in a wireline fiber deployment, in accordance with embodiments of the present disclosure;

FIG. 2B is a top view of an alternative magnetic clamp assembly having one or more adjustable clamping mechanisms, the alternative magnetic clamp assembly for use in a wireline fiber deployment, in accordance with embodiments of the present disclosure;

FIG. 3 is a diagram of an example of a deployment of a wireline fiber assembly in a wellbore, in accordance with embodiments of the present disclosure;

FIG. 4A is a side view of a helical deployment of a wireline fiber assembly having magnetic clamps coupled to a casing of a wellbore, in accordance with embodiments of the present disclosure;

FIG. 4B is a top view of a helical deployment of a wireline fiber assembly having magnetic clamps coupled to a casing of a wellbore, in accordance with embodiments of the present disclosure;

FIG. 5A is a cross-sectional diagram of an elongated magnetic clamp assembly with an internal guide for a fiber optic cable, in accordance with embodiments of the present disclosure;

FIG. 5B is a cross-sectional diagram of an elongated magnetic clamp assembly with an internal guide for a fiber optic cable, in accordance with embodiments of the present disclosure;

FIG. 5C is a cross-sectional diagram of an elongated magnetic clamp assembly with an internal guide for a fiber optic cable, in accordance with embodiments of the present disclosure;

FIG. 5D is top view diagram of a magnetic clamp assembly with an internal guide for a fiber optic cable, in accordance with embodiments of the present disclosure;

FIG. 6A is an isometric, partially transparent diagram of a magnetic clamp assembly with a bimetallic thermal strip for preferential clamping to a casing of a wellbore, in accordance with embodiments of the present disclosure;

FIG. 6B is a side view diagram of a magnetic clamp assembly with a bimetallic thermal strip for preferential clamping to a casing of a wellbore, in accordance with embodiments of the present disclosure;

FIG. 7A is perspective view of a wireline fiber assembly having magnetic clamps with stiff members disposed between each of the magnetic clamps to introduce slack in a fiber optic cable, in accordance with embodiments of the present disclosure;

FIG. 7B is a perspective view of a magnetic clamp on a wireline fiber assembly having stiff members disposed on either side of the magnetic clamp to introduce slack in a fiber optic cable, in accordance with embodiments of the present disclosure;

FIG. 8 is a flow chart of a method for deploying a wireline fiber assembly in a wellbore, in accordance with embodiments of the present disclosure; and

FIG. 9 is a flow chart of a method of deploying and retrieving a wireline fiber assembly in a wellbore during a downhole monitoring campaign, in accordance with embodiments of the present disclosure.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose. Additionally, like reference numerals may be used for like components, but such use should not be interpreted as limiting the disclosure.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions. Moreover, references to “substantially” or “approximately” or “about” may refer to differences within ranges of +/- 10 percent.

Furthermore, like numbers may be used to refer to like elements throughout, but it should be appreciated that using like numbers is for convenience and clarity and not intended to limit embodiments of the present disclosure. For example, one or more subsequent figures may share similar features with one or more prior figures and the similar features may be identified with like reference numerals for convenience purposes only and not to limit the scope of the present disclosure.

Embodiments of the present disclosure are directed toward methods, systems, and apparatuses for the safe deployment and retrieval of a temporary wireline fiber within a cased wellbore. In various embodiments, a wireline fiber may be mechanically coupled to an inner surface of casing using one or more magnetic clamp assemblies that provide repeatable and controllable attachment during deployment and predictable uncoupling during retrieval. The approaches described herein may enhance mechanical coupling between the fiber and casing in temporary wireline fiber running, rather than permanent installations, which may improve sensitivity to acoustic and seismic energy, including broadside waves, while maintaining wireline loads within defined safety limits. In some embodiments, the techniques may accommodate upset or non-uniform casing geometries, enabling effective coupling under realistic downhole and operational conditions. Additionally, the techniques may enable controlled retrieval without exceeding pullout load ratings of the clamp assemblies or rig-in load ratings of deployment equipment.

In various embodiments, each magnetic clamp assembly may include a permanent magnet having axial magnetic poles positioned between ferromagnetic contact surfaces, an outer holder assembly, and an internal guide that routes the fiber. The outer holder assembly may be formed from polyether ether ketone (PEEK), stainless steel, or other compatible materials. In some embodiments, the outer profile is conical with tapered ends to reduce mechanical interference during descent and recovery, particularly through upset casing sections. In other embodiments, the outer profile may be asymmetrical relative to a wireline axis to promote non-uniform contact with the casing and to increase sensitivity to acoustic energy propagating perpendicular to the wellbore axis, including broadside seismic waves.

In some embodiments, the wireline fiber may be routed through an internal guide within the clamp assembly. In various embodiments, the internal guide defines an orthogonal or tortuous path that introduces a non-vertical orientation of the fiber relative to the casing, which may facilitate detection of acoustic or electromagnetic waves at a plurality of directions. In some embodiments, adjacent magnetic clamp assemblies may be configured to attach in a helical pattern along the casing wall, thereby distributing mechanical load, increasing spatial sampling, and reducing the likelihood of continuous alignment along a single azimuth.

During deployment and retrieval, wireline tension may be continuously monitored and controlled so that operational loads remain below a working load safety limit and below pullout load ratings of the magnetic clamp assemblies and associated equipment. In some embodiments, controlled uncoupling of the magnetic clamp assemblies may be achieved using a sliding sleeve on the wireline, enabling predictable release within allowable load limits.

Additional embodiments may incorporate a bimetallic thermal strip on at least one clamp assembly. At elevated borehole temperatures, the strip may expand radially to bias preferential attachment toward one side of the casing, promoting stable coupling across varying thermal conditions. In further embodiments, a stiff member positioned between adjacent clamps may bias neighboring clamps toward opposite sides of the casing to promote alternating-side attachment and improved azimuthal coverage.

Together, these features described herein may provide a robust and repeatable approach for temporary wireline fiber deployment and retrieval in cased wellbores. The embodiments described herein may prioritize safe operational limits while achieving consistent mechanical coupling to the casing, accommodating upset or non-uniform casing geometries, and enhancing detection of acoustic and seismic energy, including broadside waves.

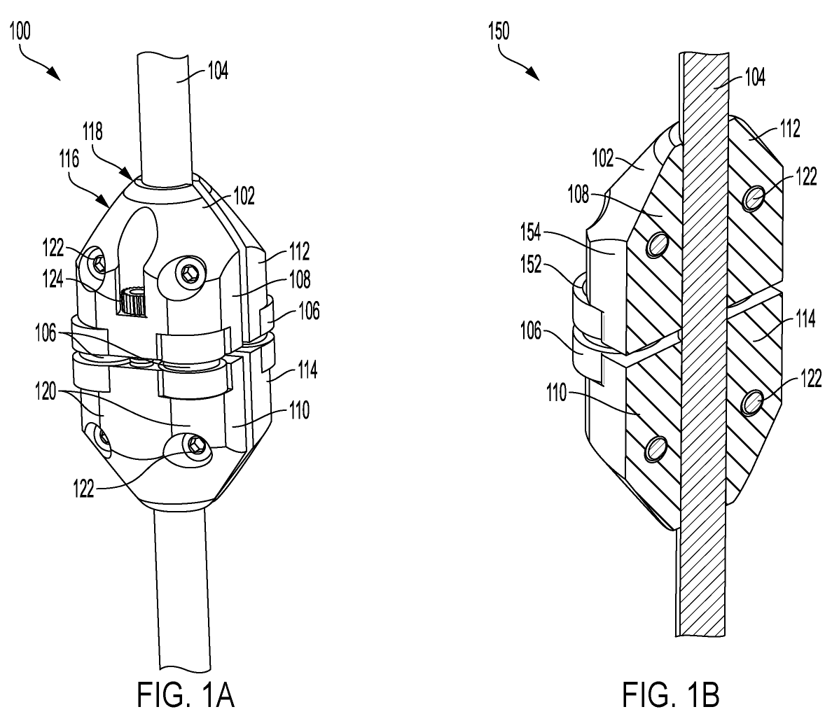

FIG. 1A is a perspective view of a magnetic clamp assembly 100 having a clamp body 102 attached to a fiber optic cable 104 passing through the clamp body 102. The magnetic clamp assembly 100 may include one or more magnets 106 disposed within the clamp body 102. In the embodiment illustrated in FIG. 1A, there are four magnets 106 positioned around the exterior of the clamp body 102 (three magnets 106 can be seen in the perspective view of FIG. 1A, with the fourth magnet 106 out of view in the rear of the magnetic clamp assembly 100). However, it should be appreciated that there may be any reasonable number of magnets 106 provided in the magnetic clamp assembly 100. The magnets 106 may have a substantially cylindrical, disk, rounded, or spherical shape, depending on the embodiment. Further, the magnets 106 may have axial magnetic poles positioned between ferromagnetic contact surfaces. In some embodiments, the permanent magnet is a ceramic permanent magnet. In one or more embodiments, the magnets 106 may be neodymium magnets, Alnico 5 magnets, ceramic magnets, or any other type of suitable permanent magnet.

The magnetic clamp assembly 100 may include a central bore that the fiber optic cable 104 passes through from one end of the magnetic clamp assembly 100 to the other. The central bore may be a defined size to fit a specific diameter of the fiber optic cable 104, or the magnetic clamp assembly 100 may be adjustable so that it may accommodate multiple diameters of fiber optic cable 104 that the magnetic clamp assembly 100 is to attach to.

In various embodiments, the clamp body 102 may include one or more body portions or sections in which the clamp body 102 is generally subdivided into. In the embodiment illustrated in FIG. 1A, the clamp body 102 includes a first body portion 108, a second body portion 110, a third body portion 112, and a fourth body portion 114. However, it should be appreciated that the clamp body 102 may include just two body portions—a first and second body portion 108, 110—or any other reasonable number of body portions, which may depend on how many magnets 106 are included in the magnetic clamp assembly 100 or the general shape of the clamp body 102.

The one or more magnets 106 may be positioned between the first and second body portion 108, 110, where a first portion of the one or more magnets 106 is housed partially within the first body portion 108 and a second portion of the one or more magnets 106 is housed partially within the second body portion 110. There also may be another portion of the one or more magnets 106 existing outside of the first and second body portions 108, 110, for example, in a gap between the first and second body portions 108, 110. In addition or instead, the one or more magnets 106 may be positioned between the third and fourth body portion 112, 114 in a similar manner. An additional portion of the one or more magnets 106 may also extend beyond an exterior surface of the clamp body 102, such that the one or more magnets 106 protrude from the exterior surface of the clamp body 102. Such a configuration can be seen in FIG. 1A and is further discussed with reference to FIG. 1B. A portion of the one or more magnets 106 extending beyond the exterior surface of the clamp body 102 may allow for direct contact of the one or more magnets 106 with the internal surface of the casing of the wellbore (internal surface, casing, and wellbore not depicted in FIG. 1A), which may thereby increase magnetic coupling strength of the magnetic clamp assembly 100 to the casing.

The clamp body 102 may have a generally conical outer profile, generally cylindrical outer profile, or any other reasonable outer profile shape. The clamp body 102 illustrated in FIG. 1A includes a tapered end 116 on each end of the magnetic clamp assembly 100, proximate to the fiber optic cable 104. The tapered ends 116 may have one or more sub-tapers 118 on the tapered ends 116 of the clamp body 102. The tapered ends 116 and/or the one or more sub-tapers 118 may facilitate the deployment of the magnetic clamp assembly 100 into a wellbore during seismic monitoring campaigns. That is, the tapered ends 116 and/or the one or more sub-tapers 118 may be designed to reduce mechanical interference by reducing the ability of the magnetic clamp assembly 100 to catch, bump, snag, or otherwise get hung up on non-uniform conditions of the wellbore casing (e.g., holes, bumps, dents, sediment accumulation, etc.) during deployment or retrieval of the wireline fiber assembly into the wellbore.

The clamp body 102, and the body portions thereof, may include one or more face surfaces 120. The face surfaces 120 may provide for flush contact between the magnetic clamp assembly 100 and an internal surface of the casing of the wellbore. The face surfaces 120 may also provide stability for the magnetic clamp assembly 100, such that the magnetic clamp assembly 100 does not easily become detached from the casing. The face surfaces 120 may be provided on each of the first, second, third, and fourth body portions 108, 110, 112, and 114. Moreover, the face surfaces 120 may be provided at a first plane, a second plane, and a third plane for each of the first, second, third, and fourth body portions 108, 110, 112, and 114 (as depicted in FIG. 1A). There also may be more than three planes per body portion. Additionally, and for example, the first plane of the first body portion 108 may be vertically aligned and substantially coplanar with the first plane of the second body portion 110, the second plane of the first body portion 108 may be vertically aligned and substantially coplanar with the second plane of the second body portion 110, the third plane of the first body portion 108 may be vertically aligned and substantially coplanar with the third plane of the second body portion 110. The first plane of the third body portion 112 may be vertically aligned and substantially coplanar with the first plane of the fourth body portion 114, the second plane of the third body portion 112 may be vertically aligned and substantially coplanar with the second plane of the fourth body portion 114, and the third plane of the third body portion 112 may be vertically aligned and substantially coplanar with the third plane of the fourth body portion 114. Furthermore, one plane of the first body portion 108 may be substantially parallel to another plane of the first body portion 108. One plane of one body portion may also be substantially parallel (but non-coplanar) with another plane of another body portion.

The magnetic clamp assembly 100 may also include one or more fasteners. In the embodiment illustrated in FIG. 1A, there are one or more horizontal fasteners 122 provided in the clamp body 102. The one or more horizontal fasteners 122 may extend through bores of the first body portion 108 and the third body portion 112, securing the first and third body portions 108, 112 upon fastening. Fastening the first and third body portions 108, 112 may also clamp the fiber optic cable 104, securing the fiber optic cable 104 to the magnetic clamp assembly 100. Furthermore, the one or more horizontal fasteners 122 may extend through bores of the second body portion 110 and the fourth body portion 114, securing the second and fourth body portions 110, 114 upon fastening. Fastening the second and fourth body portions 110, 114 may also clamp the fiber optic cable 104, securing the fiber optic cable 104 to the magnetic clamp assembly 100.

Additionally, there may be one or more vertical fasteners 124 provided in the clamp body 102. The one or more vertical fasteners 124 may extend through bores of the first body portion 108 and the second body portion 110, securing the first and second body portions 108, 110 upon fastening. Fastening the first and second body portions 108, 110 may also clamp the one or more magnets 106 that are provided between the first and second body portions 108, 110, securing the one or more magnets 106 within the magnetic clamp assembly 100. Furthermore, the one or more vertical fasteners 124 may extend through bores of the third body portion 112 and the fourth body portion 114, securing the third and fourth body portions 112, 114 upon fastening. Fastening the third and fourth body portions 112, 114 may also clamp the one or more magnets 106 that are provided between the third and fourth body portions 112, 114, securing the one or more magnets 106 within the magnetic clamp assembly 100.

FIG. 1B is a cross-sectional perspective view of the magnetic clamp assembly 150, having many of the same features as the magnetic clamp assembly 100 of FIG. 1A. The magnetic clamp assembly 150 may include the clamp body 102 attached to a fiber optic cable 104 passing through the clamp body 102, such as in FIG. 1A. A magnet 106 can be seen in the illustration, as well as cross-sections of the one or more horizontal fasteners 112 extending through each of the first body portion 108, the second body portion 110, the third body portion 112, and the fourth body portion 114.

As previewed with respect to FIG. 1A, an exterior portion 152 of the magnet 106 can be seen as extending past an exterior surface 154 of the clamp body 102. The exterior portion 152 of the magnet 106 may allow for direct contact of the magnet 106 with an internal surface of the casing of the wellbore (internal surface, casing, and wellbore not depicted in FIG. 1B), which may thereby increase magnetic coupling strength of the magnetic clamp assembly 150 to the casing. Ensuring magnetic coupling of the magnetic clamp assembly 150 with the casing allows the fiber optic cable 104 to be positioned proximate to the casing as possible, such that the fiber optic cable 104 is mechanically coupled to the casing. Ensuring mechanical coupling of the fiber optic cable 104 to the casing may provide an increase in sensitivity of the fiber optic cable 104 to seismic energy (e.g., broadside waves) improving the success of short-duration monitoring programs or post-completion diagnostic campaigns. In contrast, if the fiber optic cable 104 is distant from the casing in the wellbore, the detection of seismic energy will be compromised.

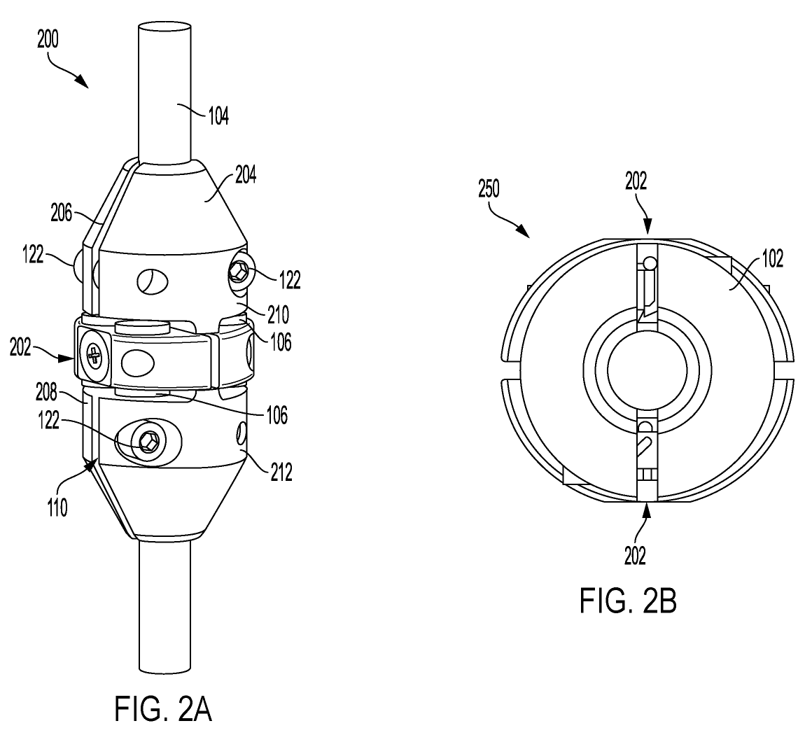

FIG. 2A is a perspective view of an alternative magnetic clamp assembly 200 having an adjustable clamping mechanism 202. The alternative magnetic clamp assembly 200 has some of the same features as the magnetic clamp assembly 100 of FIGS. 1A and 1B, such as the one or more magnets 106, the fiber optic cable 104, and the horizontal fasteners 122. An alternative clamp body 204 of the alternative magnetic clamp assembly 200 may be provided in one or more body portions, such as two body portions, four body portions, or another other reasonable number of body portions. In the embodiment illustrated in FIG. 2A, the clamp body 102 is provided with a first alternative body portion 206, a second alternative body portion 208, a third alternative body portion 210, and a fourth alternative body portion 212. Each of the first, second, third, and fourth alternative body portions 206, 208, 210, 212 may have rounded surfaces, such as shown in FIG. 2A. Each of the first, second, third, and fourth alternative body portions 206, 208, 210, 212 may instead have face surfaces, such as what is depicted in FIGS. 1A and 1B, with respect to the magnetic clamp assemblies 100, 150.

The adjustable clamping mechanism 202 may be provided as a latch, a screw, a winch, a cam lock, a toggle clamp, or any other type of clamping mechanism. Increasing the clamping force will secure the alternative magnetic clamp assembly 200 around the fiber optic cable 104; it may further secure the one or more magnets 106 within the clamp body 204 of the alternative magnetic clamp assembly 200. In embodiments, the alternative magnetic clamp assembly 200 may rely on the adjustable clamping mechanism 202 alone for securing the alternative magnetic clamp assembly 200 to the fiber optic cable 104. Such embodiments may include fasteners (vertical, horizontal, diagonal, etc.).

FIG. 2B is a top view of an alternative magnetic clamp assembly 250, with many of the same features as the alternative magnetic clamp assembly 200 of FIG. 2A. The adjustable clamping mechanisms 202 (two of them are shown in FIG. 2B) may be provided on two opposite sides of the alternative magnetic clamp assembly 200, 180 degrees from each other. In other embodiments, the alternative magnetic clamp assembly 200 may only have a single adjustable clamping mechanism 202. In some other embodiments, two or more adjustable clamping mechanisms 202 are provided on the same half of the alternative magnetic clamp assembly 200.

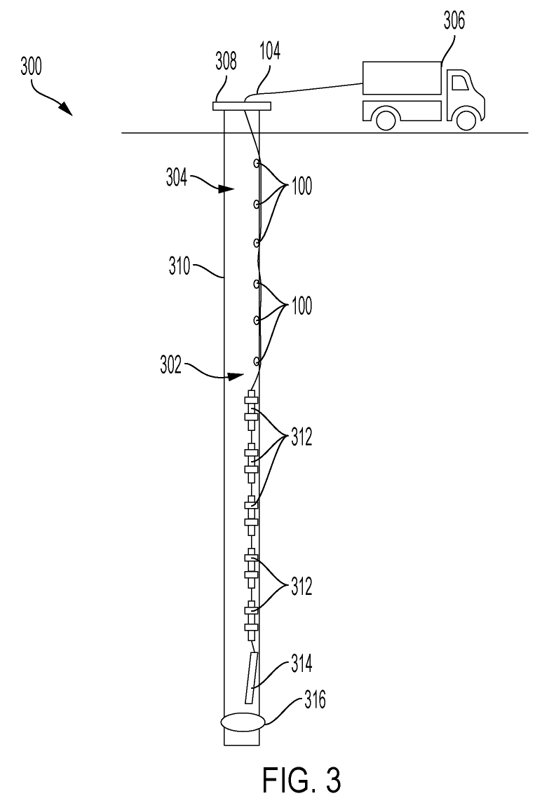

FIG. 3 is a diagram of an example of a deployment 300 of a wireline fiber assembly 302 in a wellbore 304. In FIG. 3, the fiber optic cable 104 is deployed by surface equipment of a wireline unit 306 (e.g., truck or skid-mounted equipment). The surface equipment of the wireline unit 306 may include safety, monitoring, and support equipment, such as a tension monitoring system, and may monitor and control wireline loads to ensure loads are beneath working load limits of the wireline, pullout load ratings of any coupling mechanisms, and rig-in or handling limits of the surface equipment 306. The surface equipment of the wireline unit 306 may monitor and control wireline loads within defined safety limits as well.

The fiber optic cable 104 is lowered into a wellhead 308 atop the wellbore 304 and lowered down the length of the wellbore 304. As depicted in FIG. 3, the wellbore 304 includes a casing 310 that is disposed inside the wellbore 304 and extends along a longitudinal axis (e.g., extends downward along a vertical axis) of the wellbore 304.

The wireline fiber assembly 302 may include a fiber optic cable 104 and one or more magnetic clamp assemblies 100 attached to the fiber optic cable 104. As discussed herein, the one or more magnetic clamp assemblies 100 may magnetically couple to the casing 310 of the wellbore 304. The magnetic coupling of the one or more magnetic clamp assemblies 100 may allow the fiber optic cable 104 to mechanically couple to the casing 310 of the wellbore 304 in order to improve seismic energy detection. The wireline fiber assembly 302 may also include one or more geophones 312, which may be provided to detect acoustic signals downhole. It should be appreciated that the fiber optic cable 104 may also detect acoustic signals. The wireline fiber assembly 302 may further include a sinker bar 314, which provides weight at the distal (e.g., lowest) end of the fiber optical cable 104. Also depicted in FIG. 3 is a plug 316, which may represent the bottom of the wellbore 304. The plug 316 may be a cement plug or a mechanical device placed to block or seal the bottom of the wellbore 304.

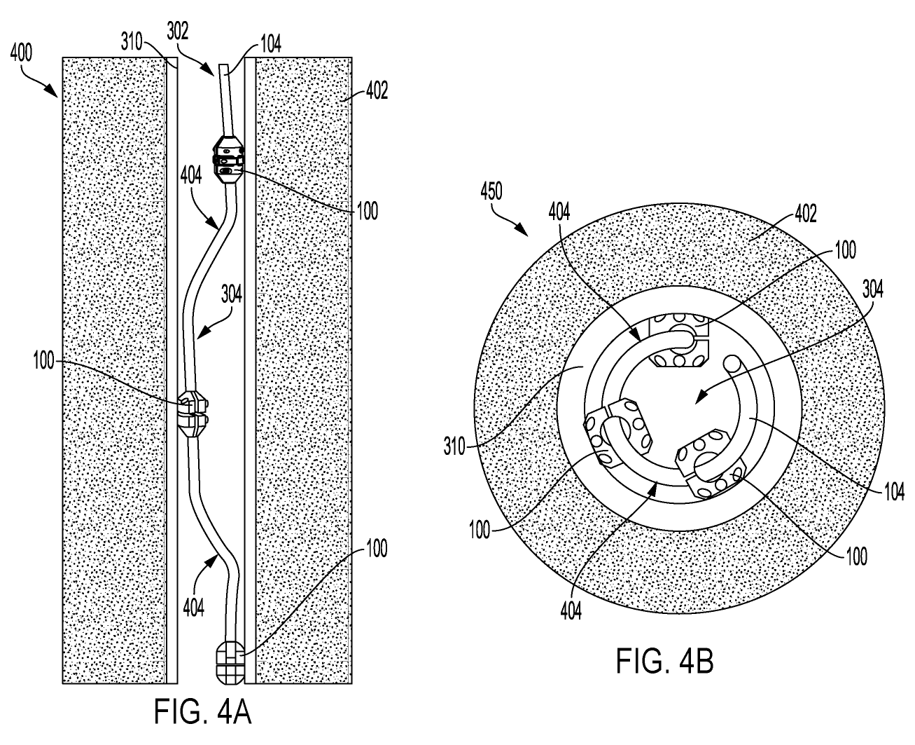

FIG. 4A is a side view of a helical deployment 400 of a wireline fiber assembly 302 including one or more magnetic clamp assemblies 100 coupled to an inner surface of a casing 310 of a wellbore 304. In the wireline fiber assembly 302, each magnetic clamp assembly 100 may be attached to a fiber optic cable 104. The wellbore 304 extends through the formation 402 within the earth, and the wellbore 304 itself may have been formed for oil and gas fracturing and/or extraction campaigns.

Although there are three magnetic clamp assemblies 100 depicted in FIG. 4A, there may be any reasonable number of magnetic clamp assemblies 100 disposed along the fiber optic cable 104 of the wireline fiber assembly 302. For example, in one or more embodiments, there may be about 15 or about 20 magnetic clamp assemblies 100 in the wireline fiber assembly 302. Because each magnetic clamp assembly 100 provides an incremental magnetic coupling force to the casing 310 of the wellbore 304, if too many magnetic clamp assemblies 100 are included in the wireline fiber assembly 302, the force necessary to decouple the magnetic clamp assemblies 100 from the casing 310, and retrieve the wireline fiber assembly 302 from the wellbore 304, may be excessive and may exceed acceptable pullout load ratings. On the other hand, if not enough magnetic clamp assemblies 100 are included in the wireline fiber assembly 302, the fiber optic cable 104 may not sufficiently mechanically couple to the casing 310 with enough strength and therefore may not provide enough sensitivity to detecting acoustic or electromagnetic waves necessary for a successful wellbore monitoring campaign.

The helical deployment 400 of the wireline fiber assembly 302 may create non-vertical or nonlinear sections 404 of the fiber optic cable 104. The existence of such non-vertical or nonlinear sections 404 in the wireline fiber assembly 302 may increase the ability of the fiber optic cable 104 to detect acoustic or electromagnetic waves propagating perpendicular to the casing 310 of the wellbore 304. In other words, the non-vertical or nonlinear sections 404 may allow for the detection of broadside waves by introducing sections 404 that are not vertical or otherwise not aligned with the wellbore 304, which, therefore, allows for the detection of these perpendicularly propagating waves. As such, the non-vertical or nonlinear sections 404 may provide an additional sensing direction and improved azimuthal diversity (this may be described as 2D or 2.5D in some implementations) for acoustic or electromagnetic waves propagating in the formation 402. Moreover, the existence of vertical sections of the fiber optic cable 104 in addition to the non-vertical or nonlinear sections 404 of the fiber optic cable 104 provides diversity of signal for detection of acoustic or electromagnetic waves propagating in the formation 402.

FIG. 4B is a top view of a helical deployment 450 of a wireline fiber assembly 302 including one or more magnetic clamp assemblies 100 coupled to an inner surface of a casing 310 of a wellbore 304. The top view of FIG. 4B displays the circular or otherwise curved nature of the casing 310 disposed in the wellbore 304. FIG. 4B shares many of the same features as FIG. 4A. As described herein, in the wireline fiber assembly 302, each magnetic clamp assembly 100 may be attached to a fiber optic cable 104. As with FIG. 4A, the wellbore 304 extends through the formation 402 within the earth. FIG. 4B further depicts the non-vertical or nonlinear sections 404 that may provide for more sensitivity to broadside wave detection.

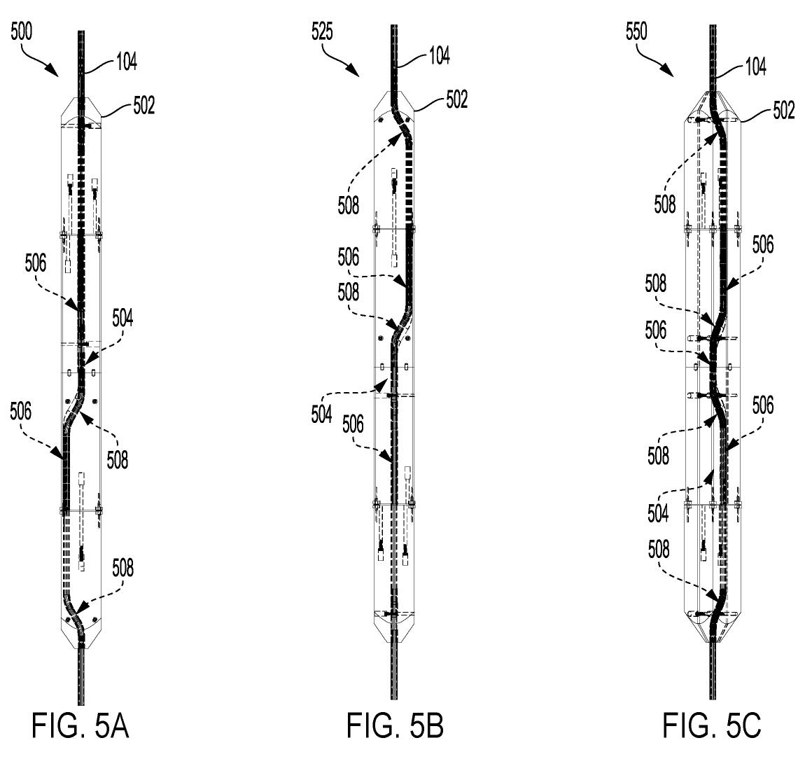

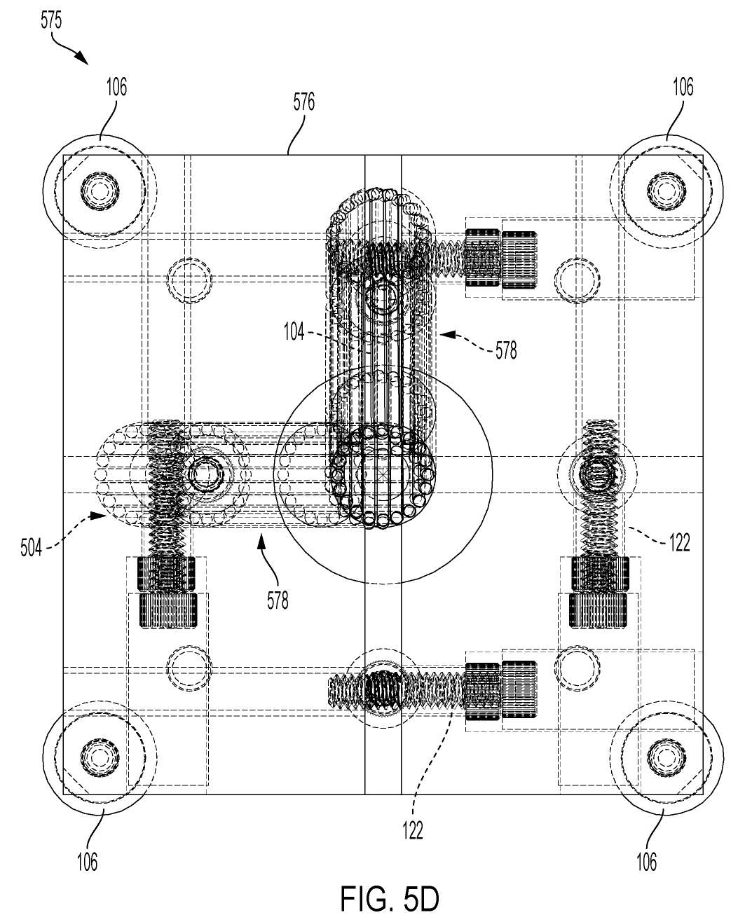

FIG. 5A is a cross-sectional diagram of an elongated magnetic clamp assembly 500 having an elongated clamp body 502. The elongated clamp body 502 may include an internal guide 504 that the fiber optic cable 104 may be routed through. The internal guide 504 may define a path through the elongated clamp body 502, and the path of the internal guide 504 may include one or more substantially vertical sections 506 and one or more substantially angled sections 508. In the embodiment illustrated in FIG. 5A, the fiber optic cable 104 and internal guide 504 are substantially vertical and linear in the vertical section 506 at the top half of the elongated magnetic clamp assembly 500. At about the middle of the elongated magnetic clamp assembly 500, the internal guide 504 routes the fiber optic cable 104 in an angled section 508 to another substantially vertical section 506. At this second vertical section 506 in the bottom half of the elongated magnetic clamp assembly 500, the fiber optic cable 104 is routed near the exterior of the elongated clamp body 502, which may be proximate to the casing of the wellbore, which, thereby, may provide for more sensitivity of acoustic or electromagnetic wave detection. Before reaching the bottom of the elongated magnetic clamp assembly 500, the internal guide 504 routes the fiber optic cable 104 in another angled section 508, before the fiber optic cable 104 exits the bottom of the elongated magnetic clamp assembly 500. As discussed herein, the angled and substantially non-vertical, non-uniaxial orientations of the fiber optic cable 104 may allow for the fiber optic cable 104 to sense broadside waves that propagate perpendicular to the casing and/or the elongated magnetic clamp assembly 500.

FIG. 5B is a cross-sectional diagram of an elongated magnetic clamp assembly 525 with many of the same features as described in reference to FIG. 5A, such as the internal guide 504, vertical sections 506, angled sections 508, and other features. The internal guide 504 for the fiber optic cable 104 of FIG. 5B follows an alternative path compared to the internal guide 504 of FIG. 5A.

FIG. 5C is a cross-sectional diagram of an elongated magnetic clamp assembly 550 with many of the same features as described in reference to FIG. 5A, such as the internal guide 504, vertical sections 506, angled sections 508, and other features. The internal guide 504 for the fiber optic cable 104 of FIG. 5C follows an alternative path compared to both the internal guides 504 of FIGS. 5A and 5B. For example, the internal guide 504 of FIG. 5C may include three vertical sections 506, as compared to the two vertical sections 506 of FIGS. 5A and 5B. In addition, the internal guide 504 of FIG. 5C may include four angled sections 508, as compared to the two angled sections 508 of FIGS. 5A and 5B. Moreover, the elongated clamp body 502 of FIG. 5C may be wider or comprise a larger volume than the elongated clamp bodies 502 of each of FIGS. 5A and 5B. A consequence of the larger elongated clamp body 502 of FIG. 5C may be that the elongated magnetic clamp assembly 550 itself is heavier or bulkier, which will increase wireline load, however it may facilitate the ability of the elongated magnetic clamp assembly 550 to magnetically couple to the casing of the wellbore and may reduce the impact of upset casing conditions.

FIG. 5D is top view diagram of a magnetic clamp assembly 575 having a clamp body 576. Within the magnetic clamp assembly 575, the internal guide 504 defines a passage through the clamp body 576 that the fiber optic cable 104 may be routed through. FIG. 5D also illustrates many of the same features discussed herein, such as the horizontal fasteners 122. Additionally, the top view of the magnetic clamp assembly 575 displays the angled portions 578 of the fiber optic cable 104 as it is routed through the internal guide 504.

Furthermore, the arrangement of the magnets 106 within the magnetic clamp assembly 575, and/or the nature of each of the magnets 106 protruding from the clamp body 102 of the magnetic clamp assembly 575, may allow two or more of the magnets 106 to make contact with the casing of the wellbore simultaneously. That is, the arrangement of the magnets 106 may allow two or more of the magnets to make contact with the casing, since the casing has a curvature and/or is substantially circular.

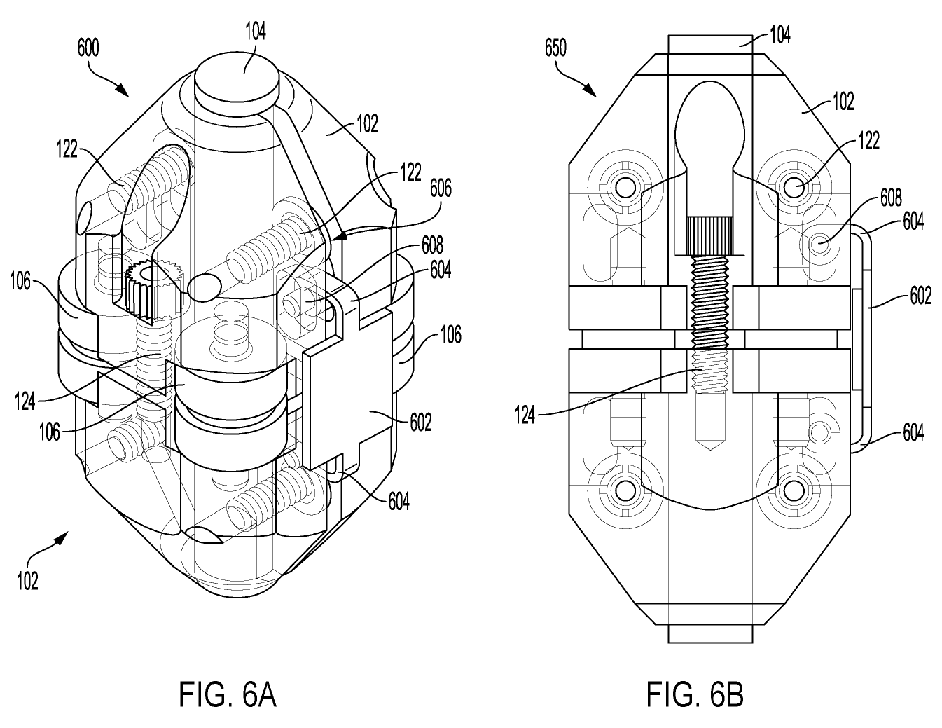

FIG. 6A is an isometric, partially transparent diagram of a magnetic clamp assembly 600. The magnetic clamp assembly 600 may include many of the same features as discussed herein, such as the clamp body 102, the fiber optic cable 104, the one or more magnets 106, and others. The magnetic clamp assembly 600 further includes a bimetallic thermal strip 602. The bimetallic thermal strip 602 may be designed to expand when exposed to elevated temperatures, and the expansion may extend axially such that the bimetallic thermal strip 602 prevents the one or more magnets 106 adjacent to the bimetallic thermal strip 602 from coupling to the casing of the wellbore during deployment of the wireline fiber assembly. Implementation of the bimetallic thermal strip 602 may provide for preferential clamping of a particular side of the magnetic clamp assembly 600 to the casing of the wellbore. As such, operators may be able to control for the orientation of the magnetic clamps assemblies 600 on the casing of the wellbore, which may facilitate the ability to detect or determine seismic activity. It should be appreciated that embodiments of the magnetic clamps that have bimetallic thermal strips 602 may also be provided in embodiments of the elongated magnetic clamp assemblies 500, 525, 550 described in FIGS. 5A, 5B and 5C.

The bimetallic thermal strip 602 may have one or more arms 604, which may provide for attachment of the bimetallic thermal strip to the magnetic clamp assembly 600. The one or more arms 604 of the bimetallic thermal strip 602 may extend through a gap 606 between adjacent body portions of the clamp body 102. The one or more arms 604 may wrap around, affix, latch, or otherwise attach to an internal bolt or screw 608 within the clamp body 102. It should be appreciated that the one or more arms 604 of the bimetallic thermal strip 602 may also be affixed to the one or more magnets 106, the one or more horizontal fasteners 122, the one or more vertical fasteners 124, or any other components of the magnetic clamp assembly 600.

FIG. 6B is a side view diagram of a magnetic clamp assembly 650. The magnetic clamp assembly 600 may include many of the same features as discussed herein, such as the clamp body 102, the fiber optic cable 104, the one or more magnets 106, and others, as well as many of the same features discussed with respect to FIG. 6A, such as the bimetallic thermal strip 602, the one or more arms 604, the gap 606, and the bolts 608. Although there is only one bimetallic thermal strip 602 incorporated in the magnetic clamp assembly 650, it should be appreciated that there may be two or more bimetallic thermal strips 602 incorporated in the magnetic clamp assembly 650. For example, there may be two bimetallic thermal strips 602, each on opposite sides of the magnetic clamp assembly 650, or each on the same half of the magnetic clamp assembly 650, solely as an example. There also may be three bimetallic thermal strips 602 incorporated in the magnetic clamp assembly 650, such that preferential magnetic coupling of the magnetic clamp assembly 650 to the casing of the wellbore occurs at one specific side of the magnetic clamp assembly 650.

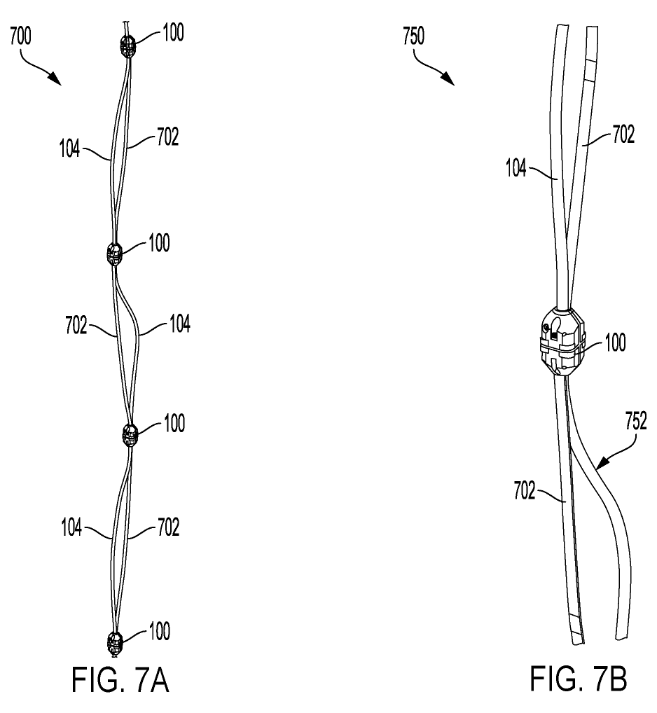

FIG. 7A is perspective view of a wireline fiber assembly 700 having a plurality of magnetic clamps 100 attached to the fiber optic cable 104. In the embodiment illustrated in FIG. 7A, the wireline fiber assembly 700 may include one or more stiff members 702 disposed between each of the magnetic clamps 100 of the wireline fiber assembly. The stiff members 702, like the fiber optic cable 104, may run between each of the magnetic clamps 100. As can be seen in FIG. 7A, the stiff members 702 may introduce slack in the fiber optic cable 104 due to, in part, that the length of fiber optic cable 104 connecting two adjacent magnetic clamps 100 is longer than the length of the stiff member 702 connecting the same two adjacent magnetic clamps 100. The slack in the fiber optic cable 104 may produce non-vertical or non-uniaxial sections in the fiber optic cable 104, the benefits of which are discussed herein.

FIG. 7B is a perspective view of a wireline fiber assembly 750 with a magnetic clamp 100 having stiff members 702 disposed on either side of the magnetic clamp 100 to introduce slack in a fiber optic cable 104, as discussed with respect to FIG. 7A.

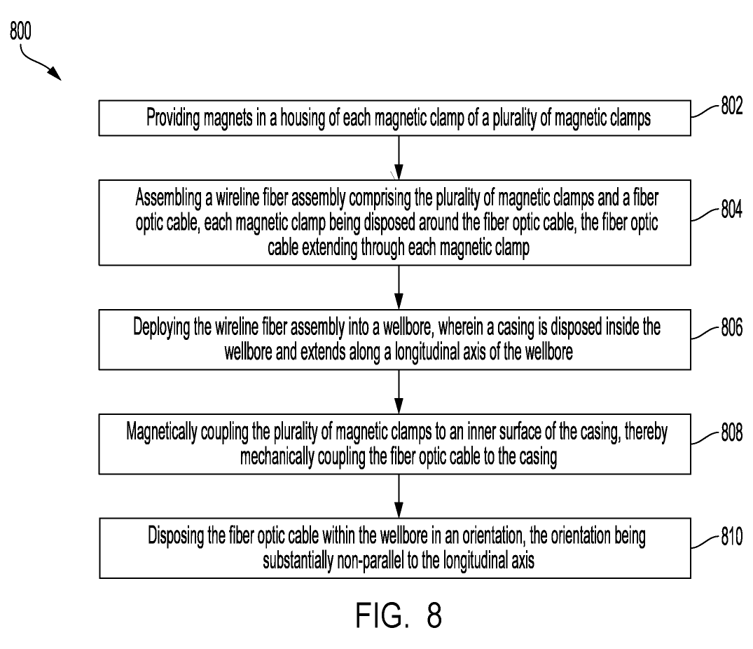

FIG. 8 is a flow chart of a method 800 for deploying a wireline fiber assembly in a wellbore. The method 800 may include providing magnets in a housing of each magnetic clamp of a plurality of magnetic clamps 802 and assembling the wireline fiber assembly having a fiber optic cable and the plurality of magnetic clamps 804. Each magnetic clamp of the plurality of magnetic clamps may be disposed around the fiber optic cable, and the fiber optic cable may extend through each magnetic clamp of the plurality of magnetic clamps. The method 800 further includes deploying the wireline fiber assembly into the wellbore 806, and a casing disposed inside the wellbore extends along a longitudinal axis of the wellbore. Additionally, the method 800 may include magnetically coupling the plurality of magnetic clamps to an inner surface of the casing, thereby mechanically coupling the fiber optic cable to the casing 808. The method 800 may further include disposing the fiber optic cable within the wellbore in an orientation, the orientation being substantially non-parallel to the longitudinal axis 810.

In various embodiments, the method 800 may include disposing the fiber optic cable within the wellbore in an orientation that is substantially helical. In one or more embodiments, the method 800 may include disposing the plurality of magnetic clamps along the inner surface of the casing in a substantially nonlinear pattern. In some embodiments, the method 800 may include at least one magnetic clamp of the plurality of magnetic clamps having an internal guide within the housing of the at least one magnetic clamp that the fiber optic cable extends through, the internal guide defining an orthogonal or tortuous route. In various embodiments, the method 800 may include attaching one or more bimetallic thermal strips to at least one magnetic clamp of the plurality of magnetic clamps, and the one or more bimetallic thermal strips may expand radially at elevated borehole temperatures to bias the at least one magnetic clamp toward preferential attachment on one side of the casing. In one or more embodiments, the method 800 may include providing one or more stiff members between at least two magnetic clamps of the plurality of magnetic clamps, and the one or more stiff members may introduce slack in the fiber optic cable.

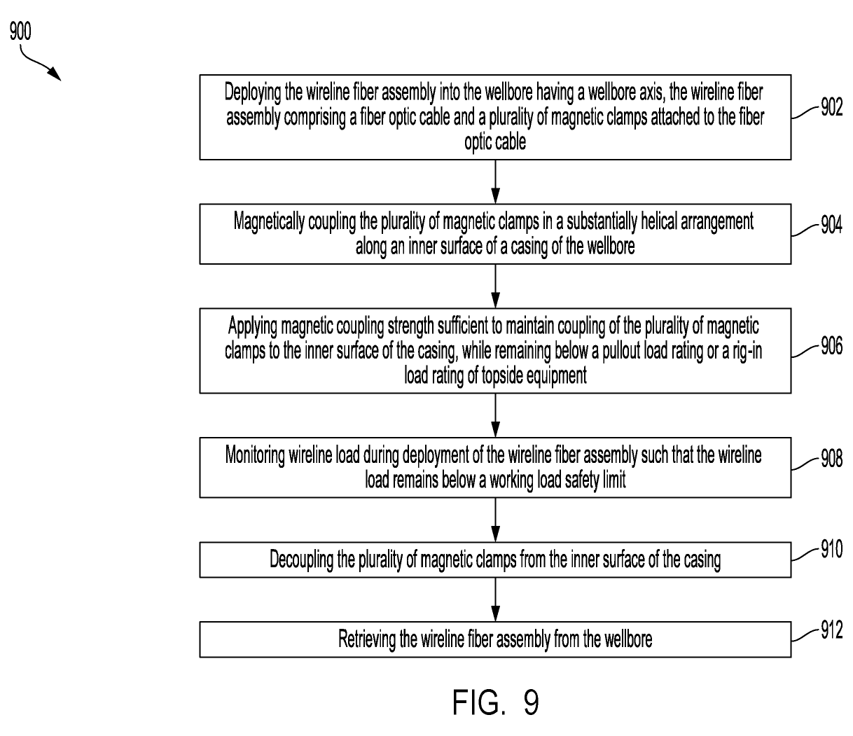

FIG. 9 is a flow chart of a method 900 of deploying and retrieving a wireline fiber assembly in a wellbore during a downhole monitoring campaign. The method 900 may include deploying the wireline fiber assembly into the wellbore having a wellbore axis 902, and the wireline fiber assembly may include a fiber optic cable and a plurality of magnetic clamps attached to the fiber optic cable. The method 900 may also include magnetically coupling the plurality of magnetic clamps in a substantially helical arrangement along an inner surface of a casing of the wellbore 904 and applying magnetic coupling strength sufficient to maintain coupling of the plurality of magnetic clamps to the inner surface of the casing, while remaining below a pullout load rating or a rig-in load rating of surface equipment 906. Additionally, the method 900 may include monitoring wireline load during deployment of the wireline fiber assembly such that the wireline load remains below a working load safety limit 908. The method 900 may further include decoupling the plurality of magnetic clamps from the inner surface of the casing 910 and retrieving the wireline fiber assembly from the wellbore 912.

In various embodiments, the method 900 may further include decoupling the plurality of magnetic clamps using a sliding sleeve on the wireline fiber assembly. In some embodiments, the method 900 may include monitoring acoustic or electromagnetic energy propagating perpendicular and non-perpendicular to the wellbore axis. In one or more embodiments, the method 900 may include providing at least one tapered end on each magnetic clamp of the plurality of magnetic clamps, and the at least one tapered end may reduce mechanical interference during deployment and retrieval. In at least one embodiment, the method 900 may further include providing one or more geophones on the wireline fiber assembly, and the one or more geophones may be magnetically coupled to the inner surface of the casing.

### Non‑limiting example embodiments

One or more embodiments of the present disclosure may further be described in view of the follow clauses associated with non-limiting example embodiments:

1. A method for deploying and retrieving a temporary wireline fiber in a cased wellbore, the method comprising:

deploying a wireline fiber assembly into the cased wellbore using a wireline.

magnetically coupling one or more magnetic clamp assemblies to an inner surface of casing during deployment to mechanically couple the wireline fiber to the casing; and

monitoring and controlling wireline load during deployment and retrieval so that the load remains below a working load safety limit.

2. The method of claim 1, wherein the method accommodates upset casing during at least one of deployment or retrieval.

3. The method of claim 1, further comprising applying magnetic clamp strength sufficient to maintain coupling while remaining below a pullout load rating and a rig-in load rating of the equipment.

4. The method of claim 1, wherein at least one magnetic clamp assembly comprises a cone-shaped outer profile configured to reduce mechanical interference during deployment and retrieval through upset casing sections.

5. The method of claim 1, wherein at least one magnetic clamp assembly is uncoupled using a sliding sleeve on the wireline.

6. The method of claim 1, wherein the magnetic clamp assemblies are configured to induce a helical clamping pattern along the casing during deployment.

7. The method of claim 1, wherein at least one magnetic clamp assembly has an outside asymmetric shape configured to increase sensitivity to acoustic energy propagating perpendicular to the wellbore axis, including broadside waves.

8. The method of claim 1, wherein the wireline fiber is routed through an internal guide within at least one magnetic clamp assembly, the internal guide defining an orthogonal or tortuous route that introduces a sub-vertical orientation of the wireline fiber relative to the casing.

9. The method of claim 1, further comprising attaching a bimetallic thermal strip to at least one magnetic clamp assembly, wherein the bimetallic thermal strip expands radially at elevated borehole temperatures to bias the magnetic clamp assembly toward preferential attachment on one side of the casing.

10. The method of claim 1, further comprising positioning a stiff member between adjacent magnetic clamp assemblies to bias adjacent magnetic clamp assemblies toward opposite sides of the casing.

11. A temporary wireline fiber deployment system comprising:

a wireline fiber;

one or more magnetic clamp assemblies coupled to the wireline fiber;

wherein the magnetic clamp assemblies are configured to magnetically couple the wireline fiber to an inner surface of casing during deployment and to permit retrieval while maintaining loads below a working load safety limit.

12. The system of claim 11, wherein each magnetic clamp assembly comprises a permanent magnet having axial magnetic poles positioned between ferromagnetic contact surfaces.

13. The system of claim 11, wherein an outer holder assembly of each magnetic clamp assembly is segmented into four or more sections.

14. The system of claim 11, wherein an outer holder assembly of each magnetic clamp assembly comprises PEEK, stainless steel, or equivalent materials.

15. The system of claim 11, wherein an outer profile of at least one magnetic clamp assembly is conical with tapered ends.

16. The system of claim 11, wherein an outer profile of at least one magnetic clamp assembly is asymmetrical relative to a wireline axis to promote non-uniform contact with the casing.

17. The system of claim 11, wherein the magnetic clamp assemblies are configured to induce a helical attachment pattern along the casing wall.

18. The system of claim 11, wherein at least one magnetic clamp assembly comprises a bimetallic thermal strip configured to expand at elevated borehole temperatures to bias attachment toward one side of the casing.

19. The system of claim 11, further comprising a stiff member positioned between adjacent magnetic clamp assemblies to enforce alternating attachment sides along the casing.

20. A magnetic clamp assembly for temporarily coupling a wireline fiber to an inner surface of casing, the magnetic clamp assembly comprising:

a permanent magnet positioned between ferromagnetic contact surfaces;

an outer holder assembly having a conical outer profile; and

an internal guide configured to route the wireline fiber through an orthogonal or tortuous route that introduces a sub-vertical orientation of the wireline fiber relative to the casing.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

What is claimed is:

1. A method for deploying a wireline fiber assembly in a wellbore, the method comprising:
providing magnets in a housing of each magnetic clamp of a plurality of magnetic clamps;
assembling the wireline fiber assembly comprising a fiber optic cable and the plurality of magnetic clamps, each magnetic clamp of the plurality of magnetic clamps being disposed around the fiber optic cable, the fiber optic cable extending through each magnetic clamp of the plurality of magnetic clamps;
deploying the wireline fiber assembly into the wellbore, wherein a casing is disposed inside the wellbore and extends along a longitudinal axis of the wellbore;
magnetically coupling the plurality of magnetic clamps to an inner surface of the casing, thereby mechanically coupling the fiber optic cable to the casing; and
disposing the fiber optic cable within the wellbore in an orientation, the orientation being substantially non-parallel to the longitudinal axis.

2. The method of claim 1, wherein the orientation is substantially helical.

3. The method of claim 1, further comprising:
disposing the plurality of magnetic clamps along the inner surface of the casing in a substantially nonlinear pattern.

4. The method of claim 1, wherein at least one magnetic clamp of the plurality of magnetic clamps comprises an internal guide within the housing of the at least one magnetic clamp that the fiber optic cable extends through, and wherein the internal guide defines an orthogonal or tortuous route.

5. The method of claim 1, further comprising:
attaching one or more bimetallic thermal strips to at least one magnetic clamp of the plurality of magnetic clamps, wherein the one or more bimetallic thermal strips expand radially at elevated borehole temperatures to bias the at least one magnetic clamp toward preferential attachment on one side of the casing.

6. The method of claim 1, further comprising:
providing one or more stiff members between at least two magnetic clamps of the plurality of magnetic clamps, wherein the one or more stiff members introduce slack in the fiber optic cable.

7. A magnetic clamp for a wireline fiber assembly, comprising:
a clamp body extending along a longitudinal axis, the clamp body comprising:
a central bore configured to receive a fiber optic cable; and
a first and a second body portion, wherein the first and second body portions each comprise at least one face surface defining a plane substantially parallel to the longitudinal axis, and comprise at least one tapered end;
one or more magnets each having a substantially cylindrical or disk shape, the one or more magnets positioned between the first body portion and the second body portion, wherein the one or more magnets protrude beyond an exterior surface of the clamp body for contact with a casing of a wellbore.

8. The magnetic clamp of claim 7, further comprising:
a third and a fourth body portion, wherein the third and fourth body portions each comprise at least one face surface defining a plane substantially parallel to the longitudinal axis, and at least one tapered end.

9. The magnetic clamp of claim 8, further comprising:
one or more additional magnets having a substantially cylindrical or disk shape, one or more additional magnets positioned between the third body portion and the fourth body portion, wherein the one or more additional magnets protrude beyond the exterior surface of the clamp body.

10. The magnetic clamp of claim 9, further comprising:
one or more horizontal fasteners disposed perpendicular to the longitudinal axis, the one or more horizontal fasteners securing the first body portion to the third body portion and securing the second body portion to the fourth body portion.

11. The magnetic clamp of claim 7, further comprising:
one or more vertical fasteners disposed parallel to the longitudinal axis, the one or more vertical fasteners securing the first body portion to the second body portion.

12. The magnetic clamp of claim 7, wherein the one or more magnets comprise axial magnetic poles positioned between ferromagnetic contact surfaces.

13. The magnetic clamp of claim 7, wherein the clamp body comprises polyether ether ketone (PEEK) or stainless steel.

14. The magnetic clamp of claim 7, further comprising:
one or more bimetallic thermal strips positioned on one or both sides of the clamp body, wherein the one or more bimetallic thermal strips configured to expand radially at elevated temperatures.

15. The magnetic clamp of claim 7, further comprising an internal guide within the clamp body, the fiber optic cable extending through the internal guide, and wherein the internal guide defines an orthogonal or tortuous route through the clamp body.

16. A method of deploying and retrieving a wireline fiber assembly in a wellbore during a downhole monitoring campaign, the method comprising:
deploying the wireline fiber assembly into the wellbore having a wellbore axis, the wireline fiber assembly comprising a fiber optic cable and a plurality of magnetic clamps attached to the fiber optic cable;
magnetically coupling the plurality of magnetic clamps in a substantially helical arrangement along an inner surface of a casing of the wellbore;
applying magnetic coupling strength sufficient to maintain coupling of the plurality of magnetic clamps to the inner surface of the casing, while remaining below a pullout load rating or a rig-in load rating of surface equipment;
monitoring wireline load during deployment of the wireline fiber assembly such that the wireline load remains below a working load safety limit;
decoupling the plurality of magnetic clamps from the inner surface of the casing; and
retrieving the wireline fiber assembly from the wellbore.

17. The method of claim 16, further comprising:
decoupling the plurality of magnetic clamps using a sliding sleeve on the wireline fiber assembly.

18. The method of claim 16, further comprising:
monitoring acoustic energy propagating perpendicular and non-perpendicular to the wellbore axis.

19. The method of claim 16, further comprising:
providing at least one tapered end on each magnetic clamp of the plurality of magnetic clamps, wherein the at least one tapered end reduces mechanical interference during deployment and retrieval.

20. The method of claim 16, further comprising:
providing one or more geophones on the wireline fiber assembly, the one or more geophones magnetically coupled to the inner surface of the casing.
